(19) United States
(12) Patent Application Publication
(10) Pub. No.: US 2006/0270340 A1
(43) Pub. Date: Nov. 30, 2006

(54) Apparatus and method for distributing signals by down-converting to vacant channels

(76) Inventors: Michael Anthony Pugel, Noblesville, IN (US); Douglas Edward Lankford, Carmel, IN (US); John Joseph Curtis, Noblesville, IN (US); Keith Rey Wehmeyer, Fishers, IN (US); Mike Arthur Derrenberger, Fishers, IN (US); Terry Lockridge, Dayton, OH (US); Andrew Eric Bowyer, Indianapolis, IN (US)

Correspondence Address: THOMSON LICENSING INC., PATENT OPERATIONS, PO BOX 5312, PRINCETON, NJ, 08543-5312, US

(21) Appl. No.: 10/549,258

(22) PCT Filed: Mar. 9, 2004
(86) PCT No.: PCT/US04/07199

§ 371 Date: Jul. 27, 2006

Related U.S. Application Data
(60) Provisional application No. 60/453,763, filed on Mar. 11, 2003.
(60) Provisional application No. 60/453,491, filed on Mar. 11, 2003.

(51) Int. Cl. H04H 1/00

(52) U.S. Cl. 455/3.02; 455/3.01

(57) ABSTRACT

A gateway apparatus is capable of distributing audio, video, and/or data signals in a household and/or business dwelling using the existing coaxial cable infrastructure. According to an exemplary embodiment, the gateway apparatus includes signal processing elements which receive signals from a satellite source and process the received signals to generate analog signals corresponding to a desired satellite transponder. A controller enables generation of the analog signals responsive to a request signal. The analog signals are provided to a client device via a coaxial cable connecting the gateway apparatus and the client device.

### CROSS REFERENCE TO RELATED APPLICATION

This application claims priority to and all benefits accruing from two provisional applications filed in the United States Patent and Trademark Office on Mar. 11, 2003, and having respectively assigned Ser. No. 60/453,491 and 60/453,763.

### BACKGROUND OF THE INVENTION

1. Field of the Invention

The present invention generally relates to the distribution of signals such as audio, video and/or data signals, and more particularly, to an apparatus and method capable of distributing such signals in a household and/or business dwelling using the existing coaxial cable infrastructure.

2. Background Information

In a satellite broadcast system, a satellite receives signals representing audio, video, and/or data information from an earth-based transmitter. The satellite amplifies and rebroadcasts these signals to a plurality of receivers, located at the dwellings of consumers, via transponders operating at specified frequencies and having given bandwidths. Such a system includes an uplink transmitting portion (i.e., earth to satellite), an earth-orbiting satellite receiving and transmitting unit, and a downlink portion (i.e., satellite to earth) including one or more receivers located at the dwellings of consumers.

For dwellings which receive signals via systems such as a satellite broadcast system, the distribution of received signals in the dwelling can be a difficult proposition. For example, many existing dwellings are equipped with coaxial cable such as RG-59 type coaxial cable, which is not readily conducive for distributing certain signals such as satellite broadcast signals. One reason coaxial cable such as RG-59 is not used to distribute such signals in a dwelling is that the coaxial cable may already be used for distributing cable broadcast signals. Accordingly, it may be difficult for signals such as satellite broadcast signals to co-exist with cable broadcast signals on the coaxial cable given its limited bandwidth. Another reason that coaxial cable such as RG-59 is not used to distribute certain signals in a dwelling is that the coaxial cable may use a portion of the frequency spectrum that is different than the frequencies occupied by the signals to be distributed. For example, signals such as satellite broadcast signals may occupy a portion of the frequency spectrum (e.g., greater than 1 GHz) which is higher than the signal frequencies that can be readily distributed over coaxial cable such as RG-59 and its associated signal splitters and/or repeaters (e.g., less than 860 MHz).

Heretofore, the issue of distributing signals such as satellite broadcast signals in a dwelling using the existing coaxial cable infrastructure (e.g., RG-59) has not been adequately addressed. While certain technologies (e.g., IEEE 1394) may be used for signal distribution within a dwelling, such technologies typically require a dwelling to be re-wired, which may be cost-prohibitive for most consumers. Moreover, existing wireless technologies may not be suitable for distributing certain types of signals, such as video signals, within a dwelling.

Accordingly, there is a need for an apparatus and method, which avoids the foregoing problems, and thereby enables audio, video, and/or data signals to be distributed in a household and/or business dwelling using the existing coaxial cable infrastructure.

### SUMMARY OF THE INVENTION

In accordance with an aspect of the present invention, a gateway apparatus is disclosed. According to an exemplary embodiment, the gateway apparatus comprises processing means for receiving signals from a satellite source and processing the received signals without demodulating the received signals to generate analog signals corresponding to a desired satellite transponder. Control means enable generation of the analog signals responsive to a request signal. The analog signals are provided to a client device via a cable connecting the gateway apparatus and the client device.

In accordance with another aspect of the present invention, a method for distributing signals from a gateway apparatus to a client device is disclosed. According to an exemplary embodiment, the method comprises steps of receiving signals from a satellite source, receiving a request signal from the client device indicating a desired satellite transponder, processing the received signals to generate analog signals corresponding to the desired satellite transponder responsive to the request signal, and providing the analog signals to the client device via a coaxial cable connecting the gateway apparatus and the client device.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram of an exemplary environment suitable for implementing the present invention;

FIG. 2 is a block diagram of the gateway apparatus of FIG. 1 according to an exemplary embodiment of the present invention;

FIG. 3 is a diagram illustrating a frequency conversion operation according to an exemplary embodiment of the present invention;

FIG. 4 is a block diagram of one of the client devices of FIG. 1 according to an exemplary embodiment of the present invention; and

FIG. 5 is a flowchart illustrating steps according to an exemplary embodiment of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

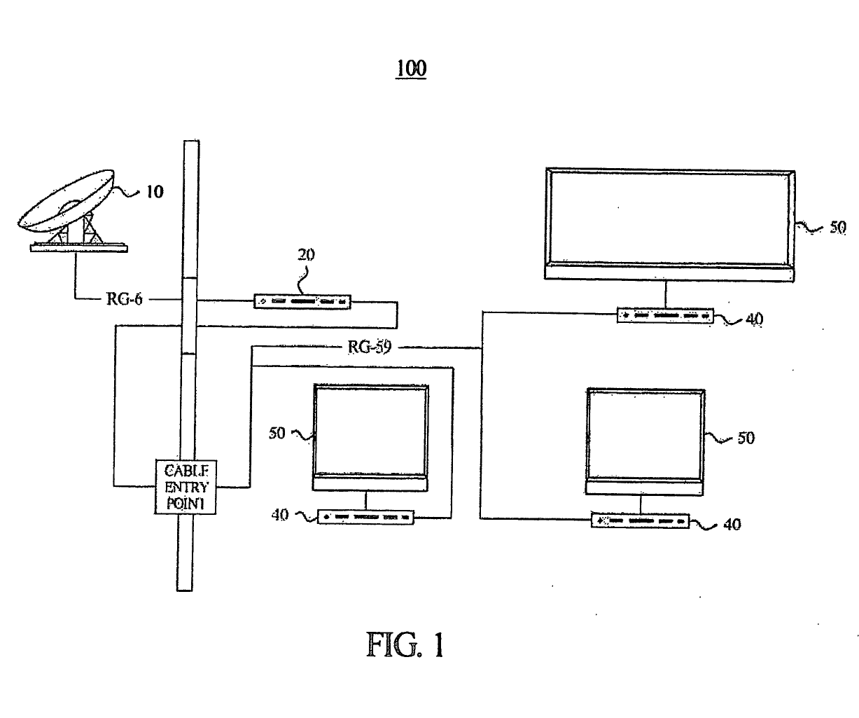

Referring now to the drawings, and more particularly to FIG. 1, a diagram of an exemplary environment 100 suitable for implementing the present invention is shown. In FIG. 1, environment 100 comprises a signal receiving element 10, a gateway apparatus 20, and client devices 40 each having an associated local output device 50. According to an exemplary embodiment, signal receiving element 10 is operatively coupled to gateway apparatus 20 via a coaxial cable connection comprised of RG-6 type coaxial cable, and gateway apparatus 20 is operatively coupled to each client device 40 via a coaxial cable connection comprised of RG-59 type coaxial cable. Other transmission media such as other types of coaxial cable, optical fibers, and air may also be used according to the present invention. Although not expressly shown in FIG. 1, environment 100 may also include elements such as signal splitters and/or repeaters. Environment 100 may for example represent a signal distribution network within a given household and/or business dwelling.

Signal receiving element 10 is operative to receive signals including audio, video, and/or data signals from one or more signal sources, such as a satellite broadcast system. According to an exemplary embodiment, signal receiving element 10 is embodied as an antenna such as a satellite receiving dish, but may also be embodied as any type of signal receiving element such as an input terminal and/or other element.

Gateway apparatus 20 is operative to receive signals including audio, video, and/or data signals from signal receiving element 10, process the received signals to generate analog signals without demodulating the received signals, and distribute the analog signals to client devices 40 via coaxial cable. According to an exemplary embodiment, each client device 40 is operative to receive and process the analog signals provided from gateway apparatus 20 to thereby enable corresponding aural and/or visual outputs via local output device 50. Each local output device 50 may be embodied as an analog and/or digital device such as a standard-definition (SD) and/or high-definition (HD) television signal receiver. Further exemplary details regarding client devices 40 will be provided later herein.

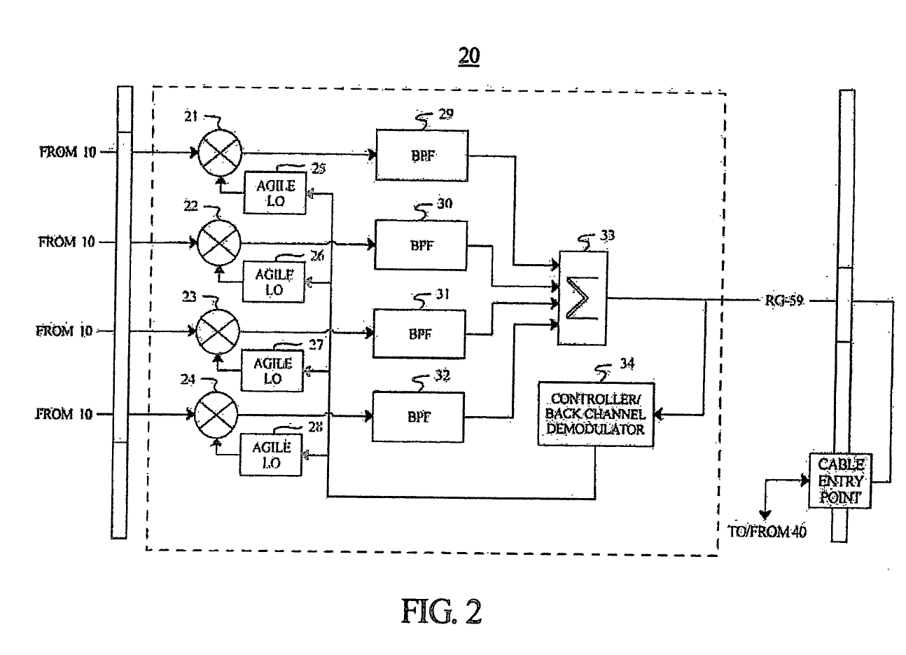

Referring to FIG. 2, a block diagram of gateway apparatus 20 of FIG. 1 according to an exemplary embodiment of the present invention is shown. In FIG. 2, gateway apparatus 20 comprises frequency converting means such as signal mixers 21 to 24 and agile local oscillators (LOs) 25 to 28, filtering means such as band pass filters (BPFs) 29 to 32, signal combining means such as signal combiner 33, and controlling/demodulating means such as controller/back channel demodulator 34. The foregoing elements of FIG. 2 may be embodied using integrated circuits (ICs), and any given element may for example be included on one or more ICs. For clarity of description, certain conventional elements associated with gateway apparatus 20 such as certain control signals, power signals and/or other elements may not be shown in FIG. 2.

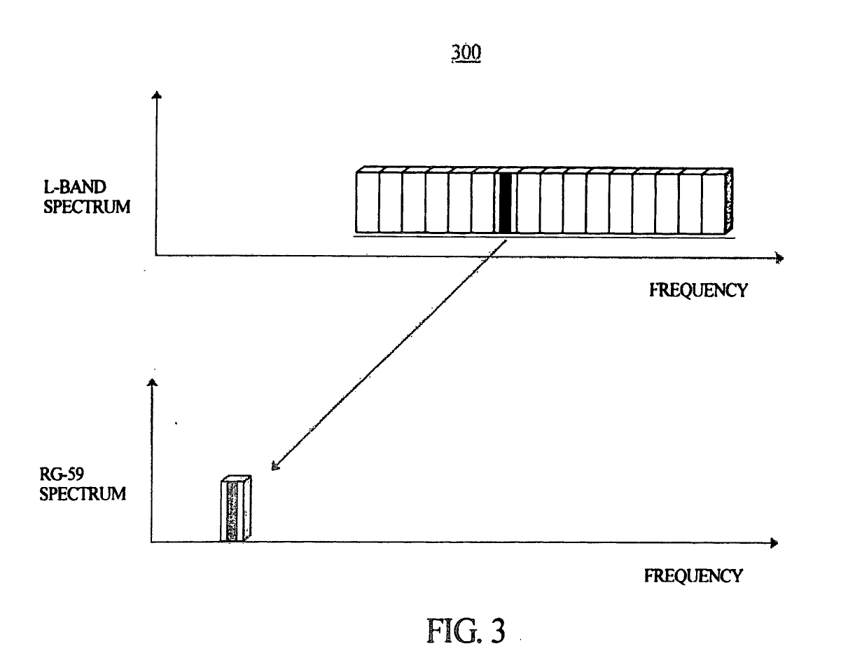

Signal mixers 21 to 24 are operative to mix signals received from a satellite broadcast source via signal receiving element 10 (e.g., and a signal splitter) with LO frequency signals provided from agile LOs 25 to 28, respectively, to thereby generate frequency converted signals. According to an exemplary embodiment, each signal mixer 21 to 24 converts the received signals from a first frequency band such as an L-band frequency (e.g., greater than 1 GHz) to a second frequency band such as a frequency band compatible for distribution over RG-59 type coaxial cable (e.g., less than 1 GHz). Moreover, each signal mixer 21 to 24 generates frequency converted signals corresponding to a particular satellite transponder. Although not expressly shown in FIG. 2, each signal mixer 21 to 24 may include an input filter to control its signal generation. FIG. 3 provides a diagram 300 illustrating the aforementioned frequency conversion operation according to an exemplary embodiment of the present invention.

Agile LOs 25 to 28 are operative to generate the LO frequency signals for signal mixers 21 to 24, respectively. According to an exemplary embodiment, each agile LO 25 to 28 generates unique LO frequency signals responsive to one or more control signals from controller 34 that enable its corresponding signal mixer 21 to 24 to generate frequency converted signals corresponding to a particular satellite transponder. For purposes of example and explanation, FIG. 2 shows four (4) sets of signal mixers 21 to 24 and corresponding agile LOs 25 to 28. In practice, the number of corresponding sets of signal mixers 21 to 24 and agile LOs 25 to 28 may be a matter of design choice. According to an exemplary embodiment, the number of corresponding sets of signal mixers 21 to 24 and agile LOs 25 to 28 may be equal to the total number of satellite transponders in a given satellite broadcast system (provided that sufficient frequency bandwidth is available) in order to ensure that broadcast signals from all transponders may be simultaneously received, processed, and distributed to client devices 40. According to another exemplary embodiment, the number of corresponding sets of signal mixers 21 to 24 and agile LOs 25 to 28 may correspond to the number of client devices 40.

BPFs 29 to 32 are operative to filter the frequency converted signals provided from signal mixers 21 to 24, respectively, to thereby generate analog signals. According to an exemplary embodiment, each BPF 29 to 32 performs a band pass filtering operation to thereby generate analog signals corresponding to a particular satellite transponder and additionally remove any spurious artifacts generated by previous signal processing that may impair these desired analog signals.

Signal combiner 33 is operative to combine the analog signals provided from BPFs 29 to 32 and output those analog signals to one or more client devices 40 using the coaxial cable connecting gateway apparatus 20 and client devices 40.

Controller/back channel demodulator 34 is operative to perform various functions of gateway apparatus 20 including control functions and back channel demodulation functions. According to an exemplary embodiment, controller 34 is operative to detect one or more available frequency bands on the coaxial cable, which may be used to provide the analog signals from gateway apparatus 20 to one or more client devices 40. Based on this detection, controller 34 generates one or more control signals, which control one or more agile LOs 25 to 28, as previously described herein.

According to an exemplary embodiment, controller 34 dynamically scans a plurality of frequency bands on the coaxial cable to thereby detect the one or more available frequency bands. The controller 34 may detect an available frequency band by measuring the signal power in that frequency band. If the signal power of a frequency band is below a threshold, the controller 34 determines that the frequency band is available. According to another exemplary embodiment, controller 34 may detect the one or more available frequency bands on the coaxial cable based on a user input. For example, a user may interact with gateway apparatus 20 via an on-screen UI provided via one or more client devices 40 which enables the user to select one or more frequency bands on the coaxial cable to be used for signal transmission between gateway apparatus 20 and client devices 40. In this manner, the user may cause certain frequency bands on the coaxial cable to be dedicated (i.e., “notched out”) for signal transmission between gateway apparatus 20 and client devices 40.

Also, according to an exemplary embodiment, back channel demodulator 34 is operative to demodulate request signals provided from client devices 40 via the coaxial cable, which may be used as a back channel. Such request signals may control the generation of frequency converted signals corresponding to desired satellite transponders by signal mixers 21 to 24 and agile LOs 25 to 28. For example, demodulated request signals generated by back channel demodulator 34 may cause controller 34 to generate corresponding control signals which control the generation of frequency converted signals corresponding to desired satellite transponders by signal mixers 21 to 24 and agile LOs 25 to 28. In this manner, request signals from client devices 40 may cause gateway apparatus 20 to provide analog signals corresponding to desired satellite transponders to client devices 40 over the coaxial cable connecting gateway apparatus 20 and client devices 40.

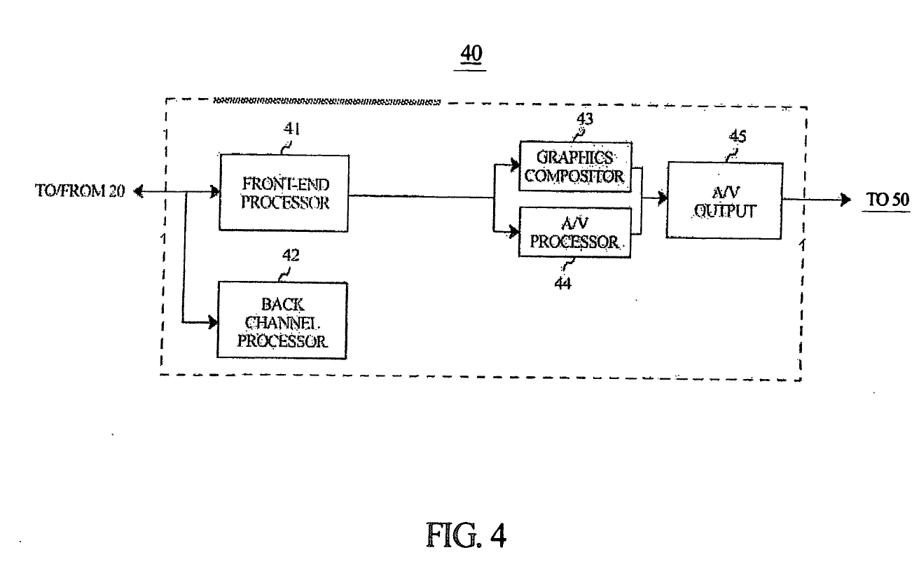

Referring to FIG. 4, a block diagram of one of the client devices 40 of FIG. 1 according to an exemplary embodiment of the present invention is shown. In FIG. 4, client device 40 comprises front-end processing means such as front-end processor 41, back channel processing means such as back channel processor 42, graphics compositing means such as graphics compositor 43, audio/video (A/V) processing means such as A/V processor 44, and A/V output means such as AN output 45. The foregoing elements of FIG. 4 may be embodied using ICs, and any given element may for example be included on one or more ICs. For clarity of description, certain conventional elements associated with client device 40 such as certain control signals, power signals and/or other elements may not be shown in FIG. 4.

Front-end processor 41 is operative to perform various front-end processing functions of client device 40. According to an exemplary embodiment, front-end processor 41 is operative to perform processing functions including channel tuning, analog-to-digital (A/D) conversion, demodulation, FEC decoding, and de-multiplexing functions. According to an exemplary embodiment, the channel tuning function of front-end processor 41 converts the analog signals provided via the coaxial cable from gateway apparatus 20 to baseband signals. As referred to herein, the term “baseband” may refer to signals, which are at, or near, a baseband level. The tuned baseband signals are converted to digital signals, which are demodulated to generate demodulated digital signals. According to an exemplary embodiment, front-end processor 41 may be operative to demodulate various types of signals such as Quadrature Amplitude Modulation (QAM) signals, Phase Shift Keyed (PSK, e.g., QPSK) modulation signals, and/or signals having other types of modulation. The FEC decoding function is applied to the demodulated digital signals to thereby generate error corrected digital signals. According to an exemplary embodiment, the FEC decoding function of front-end processor 41 may include R-S FEC, de-interleaving, Viterbi and/or other functions. The error corrected digital signals may include a plurality of time-division multiplexed broadcast programs, and are de-multiplexed into one or more digital transport streams.

Back channel processor 42 is operative to perform various back channel processing functions of client device 40. According to an exemplary embodiment, back channel processor 42 is operative to generate request signals responsive to user inputs to client device 40, and such request signals may be used to control gateway apparatus 20. For example, back channel processor 42 may generate a request signal responsive to a channel change command to client device 40, and provide the request signal to gateway apparatus 20 via the coaxial cable connecting gateway apparatus 20 and client devices 40. A given request signal may include various types of information. According to an exemplary embodiment, the request signal includes information indicating a desired transponder of the satellite broadcast system. As previously indicated herein, the request signal may cause gateway apparatus 20 to generate analog signals corresponding to the desired satellite transponder and provide those analog signals to client device 40 via the coaxial cable connecting gateway apparatus 20 and client devices 40. Other information may also be included in the request signal.

Also, according to an exemplary embodiment, back channel processor 42 is operative to detect one or more available frequency bands on the coaxial cable, which may be used to provide the request signals from client device 40 to gateway apparatus 20. According to an exemplary embodiment, back channel processor 42 may detect the one or more available frequency bands on the coaxial cable in the same manner as controller 34 of gateway apparatus 20. In particular, back channel processor 42 may dynamically scan a plurality of frequency bands on the coaxial cable to thereby detect the one or more available frequency bands, and/or may detect the one or more available frequency bands on the coaxial cable based on a user input, which selects the one or more available frequency bands.

According to a first exemplary embodiment, back channel processor 42 may also control the channel tuning function of front-end processor 41. For example, back channel processor 42 may include in a request to gateway apparatus 20 one of the available frequency bands it has dynamically detected or a frequency band selected by a user, and signal front-end processor 41 to tune that available frequency band or the frequency band selected by the user.

According to a second exemplary embodiment, back channel processor 42 may include all the available frequency bands in a request, and gateway apparatus 20 selects one of the available frequency bands to provide broadcast signals from a channel selected by a user. In the second exemplary embodiment, back channel processor 42 may dynamically scan a plurality of frequency bands on the coaxial cable after a request signal is provided to gateway apparatus 20 in order to detect a desired digital transport stream provided from gateway apparatus 20. According to this second exemplary embodiment, back channel processor 42 may process signals from the plurality of frequency bands to thereby detect a desired digital transport stream. For example, back channel processor 42 may detect program identification information in the signals from the plurality of frequency bands to thereby detect a desired digital transport stream. Once a desired digital transport stream is detected, back channel processor 42 may provide a control signal to front-end processor 41, which causes the front-end processor 41 to tune the particular frequency band on the coaxial cable that provides the desired digital transport stream.

In a third exemplary embodiment, back channel processor 42 does not include a frequency band in a request and gateway apparatus must detect an available frequency band to provide broadcast signals from a channel selected by the user. In this third exemplary embodiment, back channel should detect a desired digital transport stream and cause front-end processor 41 to tune the particular frequency band on the coaxial cable that provides the desired digital transport stream, as discussed above with respect to the second exemplary embodiment.

Graphics compositor 43 is operative to perform graphics compositing functions of client device 40, which enable graphical displays via local output device 50. According to an exemplary embodiment, graphics compositor 43 generates analog and/or digital signals, which represent graphical displays such as user interfaces (UIs), which allow users to interact with client device 40 and/or gateway apparatus 20.

A/V processor 44 is operative to perform various A/V processing functions of client device 40. According to an exemplary embodiment, A/V processor 44 is operative to perform functions including Motion Picture Expert Group (MPEG) decoding, National Television Standards Committee (NTSC) or other type of encoding, and digital-to-analog (D/A) conversion functions. In this manner, the digital transport stream provided from front-end processor 41 may be MPEG decoded to generate decoded digital signals. The decoded digital signals may then be encoded as NTSC signals or other types of signals (e.g., PAL, SECAM, VSB, QAM, etc.), and converted to analog signals. In the event, local output device 50 is a digital device such as a digital television signal receiver, the aforementioned encoding and/or D/A conversion functions may be bypassed.

A/V output 45 is operative to perform an A/V output function of client device 40 by enabling output of the analog and/or digital signals provided from graphics compositor 43 and/or A/V processor 44 to local output device 50. According to an exemplary embodiment, A/V output 45 may be embodied as any type of A/V output means such as any type of wired and/or wireless output terminal.

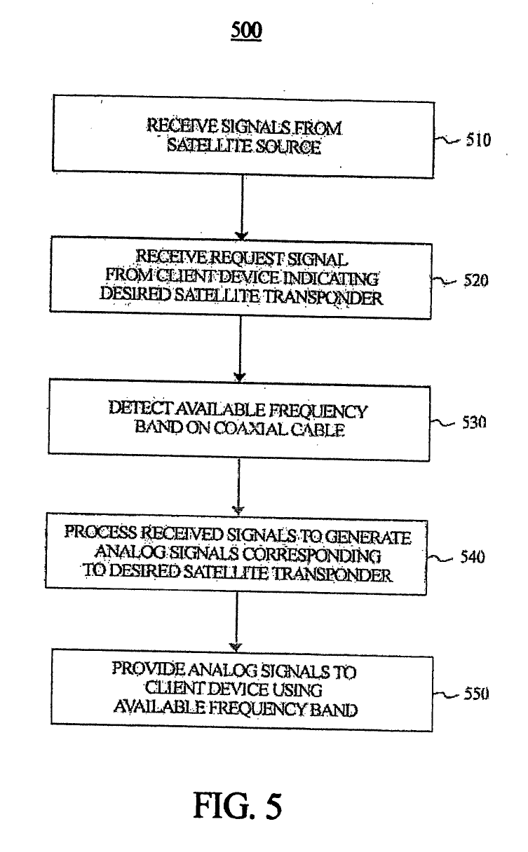

To facilitate a better understanding of the inventive concepts of the present invention, an example will now be provided. Referring to FIG. 5, a flowchart 500 illustrating steps according to an exemplary embodiment of the present invention is shown. For purposes of example and explanation, the steps of FIG. 5 will also be described with reference to the previously described elements of environment 100 of FIG. 1. The steps of FIG. 5 are merely exemplary, and are not intended to limit the present invention in any manner.

At step 510, gateway apparatus 20 receives signals provided from a satellite broadcast source. According to an exemplary embodiment, gateway apparatus 20 receives via signal receiving element 10 signals such as audio, video, and/or data signals from the satellite broadcast source.

At step 520, gateway apparatus 20 receives a request signal from a client device 40 indicating a desired satellite transponder to be tuned. According to an exemplary embodiment, back channel processor 42 of client device 40 generates the request signal responsive to a user input to client device 40 such as a channel change command, and provides the request signal to gateway apparatus 20 via the coaxial cable connecting gateway apparatus and client devices 40.

At step 530, gateway apparatus 20 detects one or more available frequency bands on the coaxial cable connecting it to client devices 40. As previously indicated herein, controller 34 may dynamically scan a plurality of frequency bands on the coaxial cable to detect the one or more available frequency bands at step 530, and/or may detect the one or more available frequency bands based on a user input which selects the available frequency bands.

At step 540, gateway apparatus 20 processes the received satellite broadcast signals to thereby generate analog signals corresponding to the desired satellite transponder. According to an exemplary embodiment, back channel demodulator 34 demodulates the request signal received at step 520 to thereby generate a demodulated request signal. The demodulated request signal causes controller 34 to generate a corresponding control signal which controls an agile LO 25 to 28 and corresponding signal mixer 21 to 24, and thereby enables the generation of frequency converted signals corresponding to the desired satellite transponder. The frequency converted signals corresponding to the desired satellite transponder are then filtered by a corresponding BPF 29 to 32 to thereby generate the analog signals corresponding to the desired satellite transponder at step 540.

At step 550, gateway apparatus 20 provides the analog signals generated at step 540 to client device 40 using the available frequency band on the coaxial cable detected at step 530. The steps of FIG. 5 may be performed a plurality of times in a simultaneous manner to thereby simultaneously provide analog signals to “N” different client devices 40. In this manner, gateway apparatus 20 may for example distribute “N” different broadcast programs to “N” different client devices 40 in a simultaneous manner.

As described herein, the present invention provides an apparatus and method capable of distributing audio, video, and/or data signals in a household and/or business dwelling using the existing coaxial cable infrastructure. The present invention may be applicable to various apparatuses, either with or without a display device. Accordingly, the phrase “television signal receiver” as used herein may refer to systems or apparatuses including, but not limited to, television sets, computers or monitors that include a display device, and systems or apparatuses such as set-top boxes, video cassette recorders (VCRs), digital versatile disk (DVD) players, video game boxes, personal video recorders (PVRs), computers or other apparatuses that may not include a display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An apparatus (20), comprising:
processing means (21-32) for receiving broadcast signals and processing said received signals to generate analog signals without demodulating the received signals;
control means (34) for enabling generation of said analog signals responsive to a request signal; and
wherein said analog signals are provided to a client device (40) via a transmission medium connecting said apparatus (20) and said client device (40).

2. The apparatus (20) of claim 1, wherein said transmission medium includes RG-59 cable.

3. The apparatus (20) of claim 1, wherein said processing means (21-32) includes:
frequency converting means (21-28) for converting said received signals from a first frequency band to a second frequency band to generate frequency converted signals; and
filtering means (29-32) for filtering said frequency converted signals to generate said analog signals.

4. The apparatus (20) of claim 3, wherein:
said first frequency band is greater than 1 GHz; and
said second frequency band is less than 1 GHz.

5. The apparatus (20) of claim 1, wherein:
said control means (34) detects an available frequency band on said transmission medium; and
said available frequency band is used to provide said analog signals to said client device (40).

6. The apparatus (20) of claim 5, wherein said control means (34) scans a plurality of frequency bands on said transmission medium to detect said available frequency band.

7. The apparatus (20) of claim 5, wherein said control means (34) detects said available frequency band based on a user input which selects said available frequency band.

8. The apparatus (20) of claim 1, wherein said request signal is provided to said apparatus (20) via said transmission medium.

9. A method (500) for distributing signals from a gateway apparatus to a device, comprising steps of:
receiving broadcast signals (510);
receiving a request signal from said device indicating a channel (520);
processing said received signals to generate analog signals corresponding to said channel responsive to said request signal (540), without demodulating said received signals; and
providing said analog signals to said device via a transmission medium connecting said gateway apparatus and said device (550).

10. The method (500) of claim 9, wherein said transmission medium includes RG-59 cable.

11. The method (500) of claim 9, wherein said processing step (540) includes:
converting said received signals from a first frequency band to a second frequency band to generate frequency converted signals; and
filtering said frequency converted signals to generate said analog signals.

12. The method (500) of claim 11, wherein:
said first frequency band is greater than 1 GHz; and
said second frequency band is less than 1 GHz.

13. The method (500) of claim 9, further comprising a step of:
detecting an available frequency band on said transmission medium (530); and
wherein said available frequency band is used to provide said analog signals to said device.

14. The method (500) of claim 13, wherein said detecting step (530) includes scanning a plurality of frequency bands on said transmission medium to identify said available frequency band.

15. The method (500) of claim 13, wherein said detecting step (530) is performed based on a user input which selects said available frequency band.

16. The method (500) of claim 9, wherein said request signal is provided to said gateway apparatus via said transmission medium.

17. An apparatus (20), comprising:
signal processing elements (21-32) operative to receive broadcast signals and process said received signals to generate analog signals without demodulating said received signals;
a controller (34) operative to enable generation of said analog signals responsive to a request signal; and
wherein said analog signals are provided to a client device (40) via a transmission medium connecting said apparatus (20) and said client device (40).

18. The apparatus (20) of claim 17, wherein said transmission medium includes RG-59 cable.

19. The apparatus (20) of claim 17, wherein said signal processing elements (21-32) include:
frequency converters (21-28) operative to convert said received signals from a first frequency band to a second frequency band to generate frequency converted signals; and
filtering means (29-32) for filtering said frequency converted signals to generate said analog signals.

20. The apparatus (20) of claim 19, wherein:
said first frequency band is greater than 1 GHz; and
said second frequency band is less than 1 GHz.

21. The apparatus (20) of claim 17, wherein:
said controller (34) is further operative to detect an available frequency band on said transmission medium; and
said available frequency band is used to provide said analog signals to said client device (40).

22. The apparatus (20) of claim 21, wherein said controller (34) scans a plurality of frequency bands on said transmission medium to detect said available frequency band.

23. The apparatus (20) of claim 21, wherein said control means (34) detects said available frequency band based on a user input which selects said available frequency band.

24. The apparatus (20) of claim 17, wherein said request signal is provided to said apparatus (20) via said transmission medium.
